(19) United States
(12) Patent Application Publication
(10) Pub. No.: US 2025/0071728 A1
(43) Pub. Date: Feb. 27, 2025

(54) SYSTEMS AND METHODS OF ASCERTAINING STATUS OF OBJECTS

(71) Applicant: Pinpoint Ideas, LLC, Okouchee, WI (US)

(72) Inventors: Joseph Czarnecky, Okauchee, WI (US); Scott Allen Crutchfield, Knoxville, TN (US)

(21) Appl. No.: 18/801,486

(22) Filed: Aug. 12, 2024

Related U.S. Application Data
(60) Provisional application No. 63/518,977, filed on Aug. 11, 2023.

(51) Int. Cl. H04W 64/00; H04W 4/029; H04W 4/38

(52) U.S. Cl. CPC H04W 64/006; H04W 4/029; H04W 4/38

(57) ABSTRACT

A system of ascertaining status of objects, including a tracking device attachable to a first object, the tracking device configured to collect and transmit status data of the first object, a software application configured to receive transmitted status data of the first object from the tracking device, and a processing unit configured to process received status data of the first object according to decision rules provided to the software application to determine if the first object is being carried by a second object, and if the processing unit determines the first object is being carried by the second object, the processing unit is configured to apply at least a portion of the received status data to the second object.

### CROSS-REFERENCE TO RELATED APPLICATIONS

This application claims the benefit of U.S. Provisional Application No. 63/518,977 filed Aug. 11, 2023, the contents of which are hereby incorporated by reference herein in their entirety.

### FIELD OF THE INVENTION

The present general inventive concept is directed to systems and methods of tracking status of objects, and more particularly, to systems and methods of gathering and processing data of one or more objects to ascertain status of one or more other objects.

### BACKGROUND

Tracking devices for tracking status of objects are well known. However, known tracking systems and methods have been less than satisfactory in providing an integrated tracking system configured to efficiently and simultaneously gather and process data of one or more objects such as boats, power sport vehicles, jet skis, all-terrain vehicles, and/or other types of assets, and applying data from such object(s) to determine status of another object(s), such as a transport trailer, based on the data gathered from the first object. It is noted that when applicant uses the term “status”, “status data,” or similar terms herein, applicant intends those terms to include past and present data, as well as predictive data in addition to current data from a certain point in time. Thus, Applicant does not intend to the terms “status data” to be limited to current data, but instead the term are intended to broadly cover historical and predictive-type data, for example data generated via machine learning or artificial intelligence (AI) techniques as well as predictive or historical status data for use in predictive maintenance, asset evaluation, future learning, etc.

### BRIEF SUMMARY

A system of ascertaining status of objects, including a tracking device attachable to a first object, the tracking device configured to collect and transmit status data of the first object, a software application configured to receive transmitted status data of the first object from the tracking device, and a processing unit configured to process received status data of the first object according to decision rules provided to the software application to determine if the first object is being carried by a second object, and if the processing unit determines the first object is being carried by the second object, the processing unit is configured to apply at least a portion of the received status data to the second object.

### BRIEF DESCRIPTION OF THE DRAWINGS

The attached figures illustrate certain aspects of the present general inventive concept, although it is understood that various modifications and/or configurations of the example embodiments can be implemented to achieve the same or similar results. Such modifications and/or equivalent configurations are intended to be encompassed within the scope of the present general inventive concept. The illustrated example embodiments are therefore representative of example techniques, arrangements, and structures configured to carry out features of the present general inventive concept, but those skilled in the art will appreciate the present general inventive concept is not limited to these example embodiments, and a wide variety of additional embodiments could be achieved using sound engineering judgement in view of the following detailed description with reference to the accompanying drawings, in which:

FIG. 1 illustrates a high-level schematic view of a system configured in accordance with an example embodiment of the present general inventive concept;

FIG. 2 illustrates a high-level schematic view of an example configuration configured in accordance with an example embodiment of the present general inventive concept;

FIG. 3 illustrates a high-level schematic view of a tracking device controller configured in accordance with an example embodiment of the present general inventive concept;

FIGS. 4A and 4B illustrate example embodiments of the present general inventive concept;

FIG. 5 illustrates an aerial view of a primary object configured with a tracking device and sensors configured in accordance with an example embodiment of the present general inventive concept; and

FIG. 6 illustrates an example dashboard including a tracking device configured in accordance with an example embodiment of the present general inventive concept.

### DETAILED DESCRIPTION

Reference will now be made to example embodiments of the present general inventive concept, examples of which are illustrated in the accompanying drawing(s) and/or described in the present specification. The example embodiments are illustrated and described herein in order to explain the present general inventive concept by referring to the figure(s) and are provided to assist the reader in gaining a comprehensive understanding of the present general inventive concept.

Example embodiments of the present general inventive concept can be achieved by providing systems and methods comprising hardware devices, firmware, sensors, and software application services configured to gather and analyze (e.g., process) data from one or more first objects to ascertain information about status one or more second objects. The system can also be configured to gather data from sensors on the second object, including data gathered from other sources such as user manuals, specification sheets, map data, warranty data, manufacturing data, maintenance data, weather data, or other sources of data related to characteristics of the first and/or second objects. In some embodiments the system can utilize machine learning data processing techniques to apply status data from the one or more first objects so as to reveal status of the one or more second objects.

For example, in some embodiments, the present general inventive concept includes a tracking device configured to collect location and/or operational data (status data) of a first object. The status data can be transmitted to a network, such as a cloud-based network comprising a software application including data processing rules, machine learning techniques, or other instructions and functions configured to analyze and process transmitted status data of the first object to reveal or ascertain information about the status of a secondary object, such as a boat trailer, based on data collected from sensors of the first object. In some embodiments, in addition to receiving and transmitting data from the first object(s) to ascertain information about the secondary object(s), the tracking device can be configured to collect and transmit data from the secondary object itself such that the data collected from the secondary object can be combined with the data collected from the first object to provide enhanced or enriched details regarding status of the secondary object.

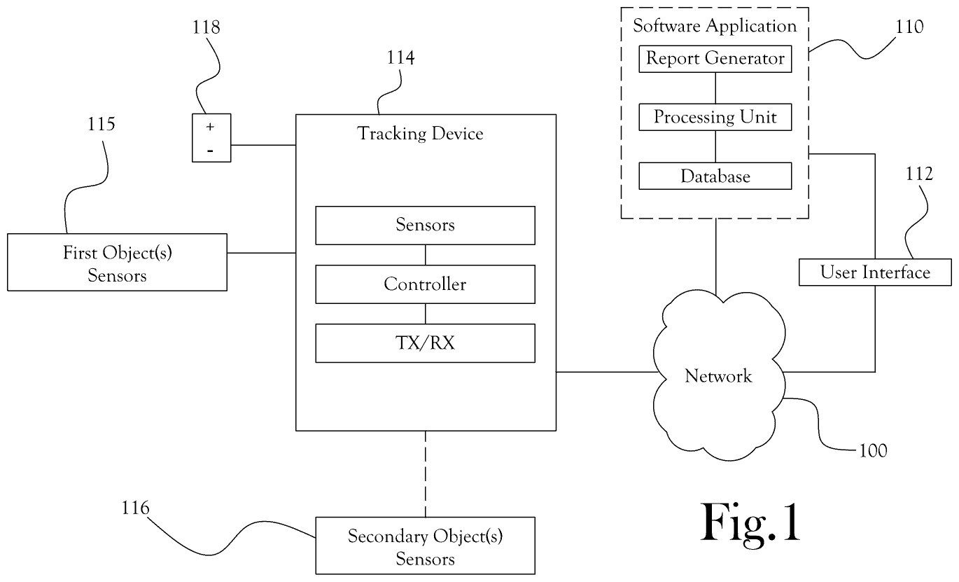

FIG. 1 illustrates a high-level schematic view of a system configured in accordance with an example embodiment of the present general inventive concept. Referring to FIG. 1, in some embodiments, the software application 110 can include, among other things, a database to store received status data, a processing unit configured to process transmitted status data obtained from one or more sensors attached to a marine vessel, such as temperature data, G-force data, battery level data, location data, speed data, weight/level data, or other parameters of interest. The processor can be configured to process this data, for example by comparing received location data to reference map data to determine whether the vessel is on land or water, by comparing received battery level data to reference data to determine whether the engine is running or not, by analyzing speed data to determine whether the boat is moving or stationary, by analyzing G-force data to determine G-forces being applied to the first object, and/or by comparing weight of the boat to reference data, and interpolating this data (e.g., data indicating the vessel is on land and data indicating the vessel is moving with the engine off, leading to the logical conclusion that the vessel is currently being hauled on a trailer. The software application can then apply this data obtained from sensors on the vessel to determine operational status of the trailer, such as how many miles has the vessel been hauled on the trailer, how fast has the trailer been moving, how much weight was on the trailer, how many G-forces were being applied to the trailer, etc. This information can then be reported or alerted to a user or other enterprise (e.g., warranty company, finance company, insurance company, or other interested party) via a report generator of the software application to determine status items such as whether the trailer is/was carrying excess weight, whether the vessel (or other object) is/was level on the trailer, whether the trailer is/was traveling at excessive speeds, whether the trailer was subject to extreme G-forces (for example by hitting curbs, potholes, etc.), vibration levels, or other conclusions about the operational status of the trailer based on status data collected and processed from sensors on the vessel itself. This data can then be used to create real-time alerts or reports to a user or enterprise indicating whether, or to the extent to which, the vessel and/or trailer may have been operated under normal conditions, or whether the object is being used for its principal purpose, or not. This data, separately or in combination with historical data and reference data, can be designed and used to provide predictive analytics, for example for future maintenance needs. The tracking device can be attached or mounted to the object and can include one or more sensors to provide data regarding status of the object, a controller to control operations of the tracking device, such as transmission/receiving of data from sensors in connection with the tracking device. The software application can include a user interface 112 to receive commands from a user. The tracking device 114 can be mounted to a first object 115 to receive data from sensors on the first object, and when the tracking device is within close proximity to secondary object sensors 116, the tracking device can sync with the secondary sensors to enrich data acquired from the first object sensors. The tracking device may be powered by an internal and/or external power source 118, such as a battery.

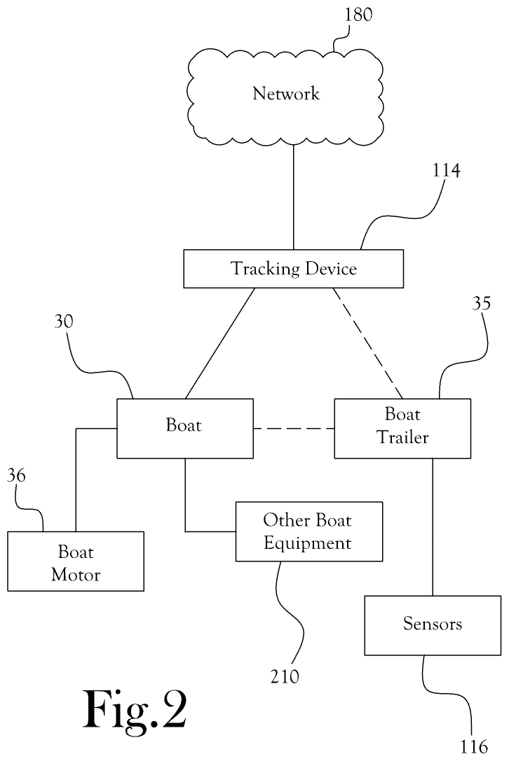

FIG. 2 illustrates a high-level schematic view of an example configuration configured in accordance with an example embodiment of the present general inventive concept. Referring to FIG. 2, a tracking device can include sensors 115 attached to a first object such as a boat 30, and optionally connected to sensors 116 of a secondary object such as a boat trailer 35. The tracking device can be configured to connect, or sync, with the sensors on the boat, as well as with optional sensors provided to the secondary boat trailer. In some embodiments, the tracking device on the first object can sync, or connect, with sensors on the second object when the tracking device is within Wi-fi or Bluetooth range of the second object sensors, such as when a boat or other object is being loaded to a transportation trailer. A user can also manually select to indicate the first object is being carried by a second object via the user interface of the software application or network.

In some example embodiments, sensors provided to the secondary object itself can include tire pressure sensors, vibration sensors, tire temperature sensors, G-force sensors, light sensors, etc. The tracking device can be configured to communicate with the sensors via Bluetooth, Wi-fi, RF or other known or later developed communication technologies. In this way, the tracking device installed on the primary object 30 can sync with sensors installed on the primary object, and optionally sync with sensors provided (if any) to the secondary object to provide status data to be transmitted from the tracking device to the software application via the network, wherein the processing unit and machine learning functions of the software application can determine, in real-time, operational status of the secondary object based, at least in part, on status data collected from sensors attached to the primary object (e.g. boat). In some embodiments, the processing unit is configured to process received status and/or operational data of the first and/or second object against reference data (such as specification data, manufacturing data, warranty data, etc.) to determine whether the data falls within acceptable ranges. It is also possible for the tracking device to collect data from the sensors on the secondary object (e.g. boat trailer) to determine operational status of the secondary object, such as whether tires are properly inflated, whether tires are exposed to extreme temperatures, whether tires or wheel bearings may be worn out, whether lights are functioning properly, whether the vessel is level on the trailer, or whether the vessel is overweight. This information can be processed to determine, among other things, whether there may be water remaining in the bilge or ballast tanks of the vessel, leading to an overweight condition for the trailer.

In some example embodiments, an integrated system can be provided for simultaneously tracking status data from sensors provided to one or more primary objects such as a marine vessel, boat, snowmobile, all-terrain vehicle, race cars, lawn mowers, motor cycles, or other power sports equipment, and processing such status data to ascertain information about the status of one or more secondary objects, such as transportation trailers, engines, etc., enabling the system to extrapolate status information about operational characteristic of the secondary objects based on data collected by a tracking device installed to the primary object. For example, the systems and methods can be configured to compare location data obtained from a GPS sensor on the boat and/or other sensors on the boat, and extrapolate the data using decision rules and/or machine learning techniques to reveal information regarding status of a trailer conveying the boat. In some embodiments, the system can be configured to provide a tracking device having one or more sensors attachable to a first object to gather information regarding status of the first object, such as if the engine is running, if the boat is moving, if the boat is on land or in water, G-forces applied, location, battery levels, 3-dimensional movements, etc. The system can be configured to gather, access, and process the data from sensors on the primary object to ascertain status of a secondary object that may be used in conjunction with the primary object, such as a transportation trailer for the primary object. The tracking device can also be configured to collect status data from a CAN bus of the primary object, and transmit this data to the software application for processing and extrapolation to reveal status of the secondary object.

Some embodiments can be configured such that the tracking device on the primary object is configured to collect status data from sensors provided to the primary object to determine operational characteristics of the secondary object, such as how many miles the trailer has traveled based on location data from a GPS component of the tracking device connected to the primary object, the speed at which the secondary object has been moving, G-forces applied to the trailer based on detected impact forces from potholes, flat tires, waves, and/or other desired pieces of information, such as whether the lights are functioning properly. Additionally, data can be applied from the tracking device on the primary object to determine characteristics of a secondary object such as a boat trailer, including if the trailer is properly level based on 3-D information obtained from sensors on the primary object, or if the trailer is overweight based on weight sensors of the primary object. This information can be processed and presented to users using a report generator including displays and/or graphical representations or other outputs configured to show various usage data, such as time in use, mileage, wear-and-tear on various components of the secondary object, including wear and tear on axles, tires, wheel bearings, lights, batteries, alarms, etc. for maintenance and/or warranty purposes. For example, in some embodiments, the system can be configured to compare data collected from a GPS sensor on the boat to know the boat is not on water, but rather is moving on land, in which case movement data, speed data, impact data, G-force data, time data, temperature data, etc. collected from the boat sensors (and/or CAN bus) can be applied to the second object, such as the boat trailer so as to reveal status information of the second object based on processing rules and/or machine learning techniques of the software application. The system can also include a report generator configured to send reports and/or alerts regarding the ascertained status of the second object to inform users in real-time regarding status of the second object.

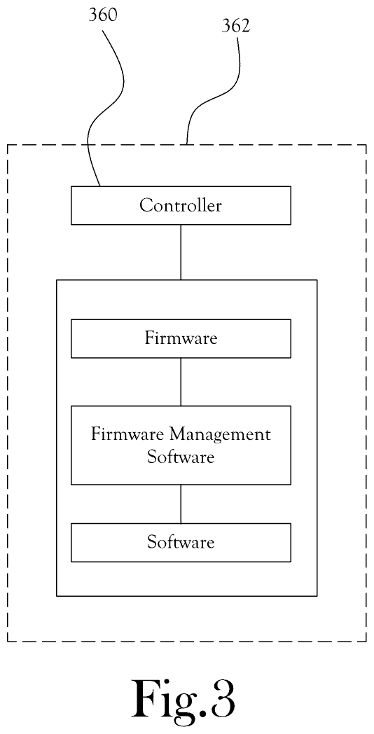

FIG. 3 illustrates a high-level schematic view of a tracking device controller 360 configured in accordance with an example embodiment of the present general inventive concept. The controller can include firmware, software, and firmware management software configured to provide a gateway 362 for data transmission TX and receipt RX between the tracking device and object sensors, and to provide instructions to the tracking device for collection and transmission of data from the object sensors to the software application.

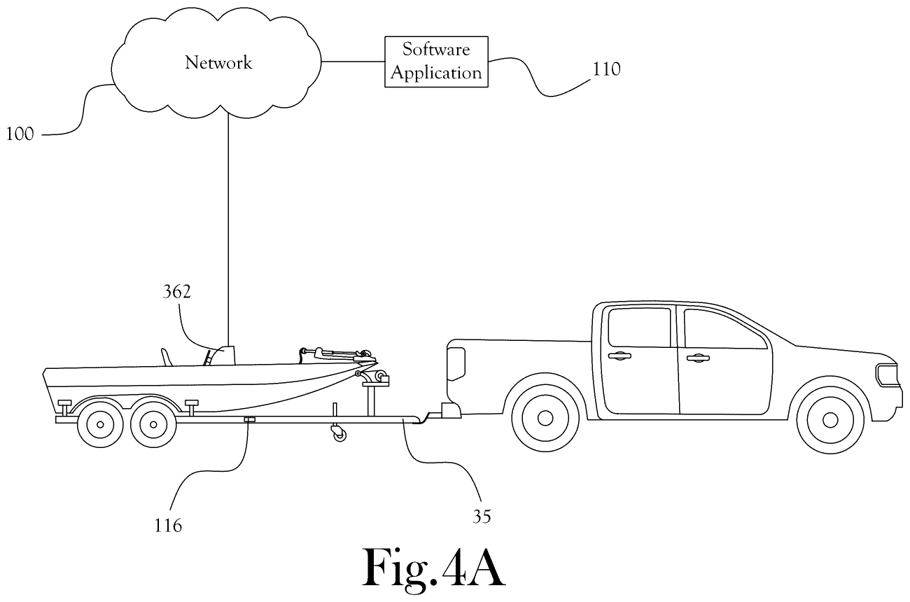

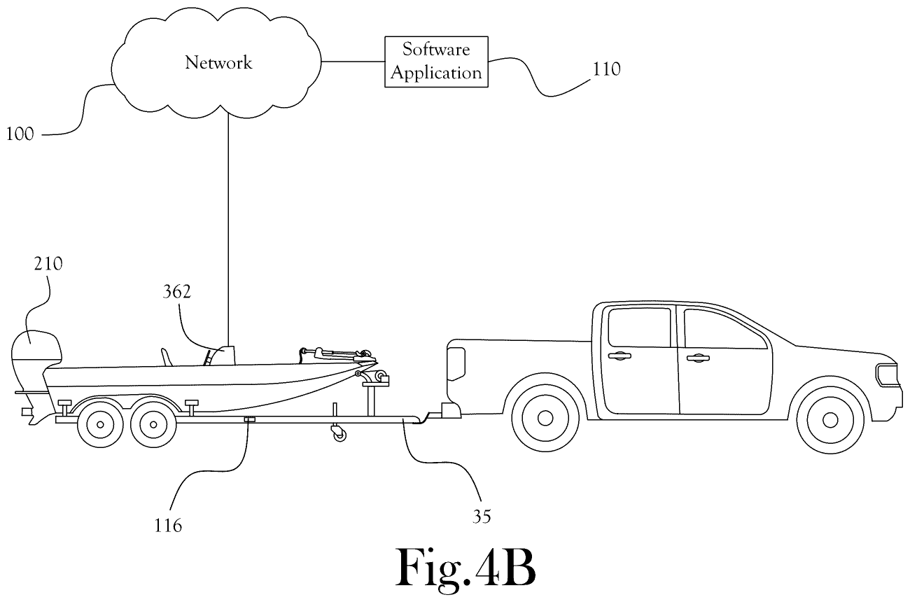

FIGS. 4A and 4B illustrate example embodiments of the present general inventive concept. Referring to FIG. 4B and FIG. 2, in some embodiments, the tracking device on the primary object can communicate with GPS tracking units that may include accelerometer sensors, X-Y-Z sensors, or gyro sensors attached to accessory (secondary) objects, such as boat engines, stereos, or other accessory equipment 210. Here, if it is determined that significant movement has occurred to the accessory object that exceeds a predetermined value, and/or if the accessory object has been moved a certain distance away from the tracking device of the primary object, the GPS device on the accessory object can wake-up and begin pinging location data to the network at various intervals based on how long the component has been missing or how far away the object is from the component to alert users and/or authorities via the software application to report the location of the removed object in real-time, serving as an anti-theft deterrent and recovery. The accessory GPS device may have an internal battery to power the accessory GPS device, and/or the accessory GPS device can be optionally connected to a self-contained battery of the accessory object, if one if available. And since the GPS device on the accessory object can be configured to wake-up only when removed from the primary object, significant cost savings related to GPS tracking of the accessory GPS device can be achieved, as well as battery conservation. Moreover, the secondary object GPS device may be configured to ping the primary object tracking device at predetermined intervals to identify the secondary object is healthy and still connected to the primary object. In some embodiments, the primary object tracking system can be configured to notify a user that the secondary object has been removed (e.g., disconnected) from the primary object, at which time the software application can present the user with GPS tracking information of the secondary object, for example via the report generator and/or user interface, to inform the user of the time and location of the accessory device in real time. The user interface can also be configured to enable the user to increase or decrease the ping rate of the accessory GPS device until the accessory object is recovered. The connection between the primary and secondary objects can be wired, wireless, Bluetooth, Wi-fi, RF, or other known or later developed communication protocols.

In some embodiments, the system can determine when a trailer or other secondary object is connected to the primary object (e.g., is trailer wiring connected to vehicle), and can determine when the secondary object is coupled/decoupled to the primary object.

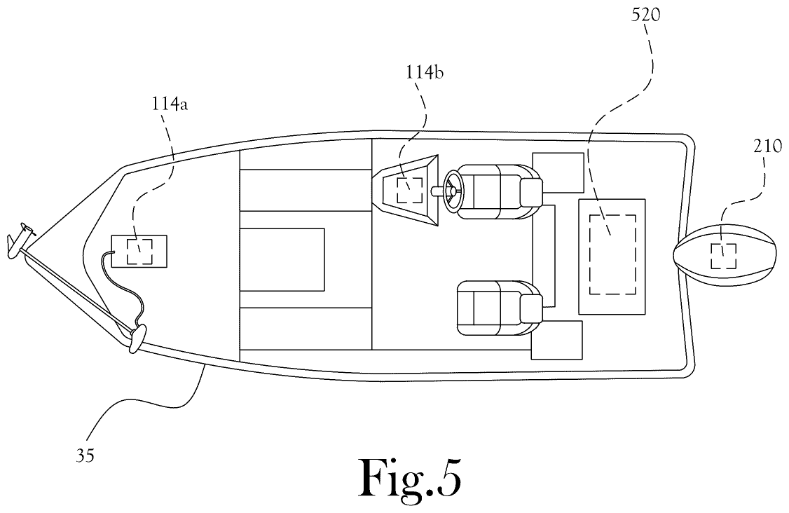

FIG. 5 illustrates an aerial view of a primary object 35 configured with one or more primary tracking devices 114a, 114b configured in accordance with an example embodiment of the present general inventive concept. Also illustrated is a CAN bus 520 to which the primary tracking devices can connect to acquire status data of the primary object, and a secondary tracking device 210 attached to an associated secondary object, such as engine. Although some of the example embodiments described herein relate to boats and boating products, the present general inventive concept is not limited thereto. Example embodiments of the present general inventive concept can be configured to operate with various other types of objects or mobile assets, such as recreational vehicles, snowmobiles, all-terrain vehicles, power sports equipment, and other objects and/or accessory devices designed for use in association with one or more such objects, such as transportation trailers, audio/visual equipment, engines, outboards, scanners, etc.

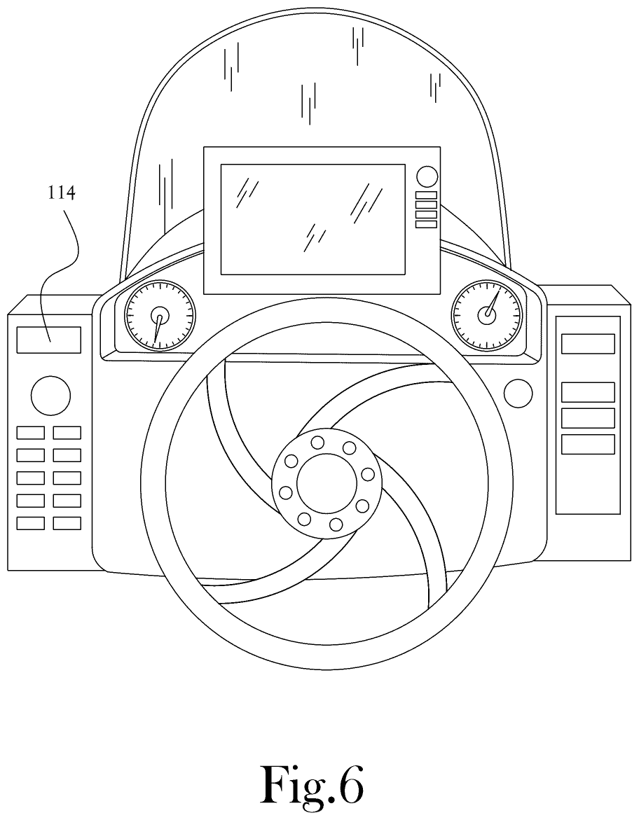

FIG. 6 illustrates an example dashboard of a first object including a tracking device 114 attached to the dashboard of a boat, but it is understood the tracking device can be attached to other parts, such as under the dash or near the battery of the primary object without departing from the scope of the present general inventive concept.

In some embodiments, the system can be configured to facilitate tracking of data through all phases of the supply chain using enhanced battery power conservation techniques based on characteristics of status data linked-to one or more associated objects. Examples can be found in applicant's prior U.S. application Ser. No. 17/166,581, the contents of which are hereby incorporated by reference herein in their entirety. For example, embodiments of the present general inventive concept can be achieved by providing a Bluetooth reader (or other known or later developed wireless communication device) configured to provide a communication gateway between the tracking device and one or more sensors attached to the primary and/or secondary objects to collect status data of the objects. In some embodiments, the system can be configured to utilize cell-phone ID or tag sensors to track various types of data, such as how many people are on the boat, who is operating the boat, how many times does a person tryout or visit a boat before purchasing. This information can be configured in report formats and graphical representations for use by the consumer user or other enterprises, such as manufacturers, dealers, warranty companies, insurance companies, finance companies, or other interested parties for production, sales, marketing, service, warranty, and use data, and/or to provide reports including historical information of how the object has been used.

As illustrated and described herein, example embodiments of the present general inventive concept can be configured to process status data obtained from a primary object such as a boat, marine vessel, or other object, and to extrapolate that data to output a report including status information of a secondary object, such as a trailer on which the boat is loaded.

The status data, or tracking information, can be based, in part, on 3-dimensional location information from a GPS component of the tracking device installed to the boat which can then be processed to generate informational reports about whether a related trailer is properly leveled, to determine if the trailer has a wheel bearing issue, to determine impacts, and/or connect and read data from sensors on the secondary object itself, for example if blinkers are working, tire pressure of trailer, etc. In some embodiments, the system can be configured to determine if brake lights, turn signals, brake connections, cameras, or other sensors on the secondary device are working properly or not.

Example embodiments can also be configured to use tracked data from a boat or other asset to extrapolate and keep records of usage of the boat trailer or other objects used in conjunction with the boat or other asset, and the software application can be configured to automatically update registration information of various devices when the trailer, engine(s), stereo, etc. are swapped to ensure records are current and accurate, for example for maintenance purposes. For example, the software application can be configured to interface with 3^{rd} party applications for warranty and/or maintenance purposes. For example, in some embodiments, the software application can be configured to generate reports such as maintenance reports and operational history details to provide interested parties, such as potential buyers, with a record, ranking, or “maintenance scorecard” based on the maintenance and usage history of the various objects. This processing can be achieved using machine learning or artificial intelligence rules and techniques.

As illustrated and described herein, it is possible to configure the systems and methods of the present general inventive concept to ascertain information regarding status of secondary objects, such as a transport trailer, including miles on a trailer, trailer wiring connections, proper leveling of the trailer, etc., based on information and data collected by a tracking device attached to a primary object or asset, such as a boat. In some embodiments, it is possible to configure the systems and methods to determine if the primary object is on land, and if so, to configure commands, functions, data, and instructions configured to associate multiple objects together and apply data from one or more first objects to ascertain status data or other characteristic information of one or more secondary objects. For example, in the case of multiple objects such as multiple snowmobiles being transported by an associated trailer, status data collected from each object via respective tracking devices can be assimilated and processed to reveal status information about the secondary trailer device.

The information can be transmitted to the software application by the tracking device and processed by the software application to provide reports to a user, such as a consumer or other enterprise, including manufacturers, dealers, finance companies, insurance companies or other interested parties so as to develop marketing, maintenance, registration, safety, and warranty information related to the primary and/or secondary objects. For example, tracked data can be mined, augmented, enriched, and processed to provide maintenance information based on usage of the boat, miles on trailer, speed of travel, type of vehicles, etc. to assist in determining status of multiple objects used in conjunction with the tracked object. This information can be processed, applied, stored, formatted, or otherwise outputted to a user, manufacturer, dealer, insurance company, or other party, for example on a subscription basis, via the user interface and/or report generator of the software application. The user interface may also be configured to receive a command from the user indicating the primary object (e.g., boat) has been connected to a secondary object (e.g., trailer), bypassing collection and processing of status data.

In some embodiments, battery voltage levels can be monitored to determine whether the engine is running. Movement and location data from the primary object can be processed to ascertain in-service dates of the object. A second GPS device can also be provided to the secondary object such that if the secondary object is removed from the primary object, the system can output a signal to notify the objects have been separated from one another. It is also possible to put tags on related components associated with the primary object, such as speakers, amplifiers, recreational equipment, or other components to provide theft deterrent.

As described herein, it is understood that the systems, apparatus, methods, processes, functions, rules, machine learning techniques, and/or data analysis operations for implementing embodiments of the present general inventive concept may be wholly or partially implemented in the form of a set of instructions executed by one or more programmed computer processors such as a central processing unit (CPU) or microprocessor. Such processors may be incorporated in the circuitry and components of an apparatus, server, client or other computing or data processing device operated by, or in communication with, other components of the system.

It is understood the example embodiments of the present general inventive concept may be embodied in whole or in part as a system, as one or more methods, or as one or more devices. Embodiments of the present general inventive concept may take the form of a hardware-implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, GPU, controller, etc.) that is part of a client device, server, network element, or other form of computing or data processing device/platform. The processing element or elements can be programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array (PGA or FPGA), application specific integrated circuit (ASIC), or other known or later developed circuitry and the like, specifically configured and arranged to generate signals instructing the various components to carry out the data processing functions.

As described herein, the systems, apparatus, methods, processes, functions, and/or operations for implementing the example embodiments of the present general inventive concept may be wholly or partially implemented in the form of apparatus that includes processing elements and sets of executable instructions. The executable instructions may be part of one or more software applications and arranged into software architecture. In general, embodiments of the present general inventive concept may be implemented using a set of software instructions that are designed to be executed by a suitably programmed processing element (such as a CPU, GPU (graphics processing unit), microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform.

The application models may include any suitable computer executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. The computer-executable code or set of instructions may be stored in (or on) any suitable non-transitory computer-readable medium. In general, with regards to the embodiments described herein, a non-transitory computer-readable medium may include almost any structure, technology or method apart from a transitory waveform or similar medium.

As described, the systems, apparatus, methods, processes, functions, software and/or operations for implementing the example embodiments of the present general inventive concept may be wholly or partially implemented in the form of a set of instructions executed by one or more programmed computer processors such as a central processing unit (CPU) or microprocessor. Such processors may be incorporated in the circuitry and components of an apparatus, server, client or other computing or data processing device operated by, or in communication with, other components of the system.

It is understood that the present general inventive concept as described above can be implemented in the form of control logic using computer software in a modular or integrated manner. Based on the disclosure and teachings provided herein, a person of ordinary skill in the art will know and appreciate other ways and/or methods to implement the present general inventive concept using hardware and a combination of hardware and software.

According to some example implementations, the term processing unit, controller, or processor, as used herein, may take the form of a central processing unit (CPU), or conceptualized as a CPU (such as a virtual machine). In such example implementation, the CPU or a device in which the CPU is incorporated may be coupled, connected, and/or in communication with one or more peripheral devices such as a cell phone, cloud-based application, or other known communication devices, as well as one or more displays, or output units. In other example implementations, the processing unit or processor may be incorporated into a mobile computing device, such as a smartphone or tablet computer.

Example embodiments of the present general inventive concept can be achieved by a system of ascertaining status of objects, including a tracking device attachable to a first object, the tracking device configured to collect and transmit status data of the first object, a software application configured to receive transmitted status data of the first object from the tracking device, and a processing unit configured to process received status data of the first object according to decision rules provided to the software application to determine if the first object is being carried by a second object, and if the processing unit determines the first object is being carried by the second object, the processing unit is configured to apply at least a portion of the received status data to the second object.

The status data can include movement data and operational data, and the processing unit can be configured to process the movement data to determine if the first object is moving at a speed above a predetermined level and to process the operational data to determine if an engine of the first object is on or off such that if the processing unit determines the first object is moving at a speed above a predetermined level with the engine off, the processing unit can be configured to determine the first object is being carried by the second object.

The status data can include location data, and the processing unit can be configured to determine that the first object is being carried by the second object based on a comparison of the location data to map data provided to the software application.

The status data can include movement data and the processing unit can be configured to process the movement data to determine if the first object is moving at a speed above a predetermined level such that if the processing unit determines the first object is moving at a speed above a predetermined level at a predetermined location relative to the map data, the processing unit is configured to determine the first object is being carried by the second object.

The processing unit can be configured to determine whether the first object is moving on water or land based on the location data and map data. The status data can include battery voltage level data of the first object, and wherein the processing unit is configured to determine that the first object is moving but not operating based on received battery voltage level data. The first object can include one or more sensors configured to provide the status data of the first object. The one or more sensors can include one or more of a temperature sensor, time sensor, vibration sensor, G-force sensor, XYZ sensor, accelerometer, weight sensor, and GPS sensor. The processor can be configured to indicate the second object is carrying excess weight based on weight sensor data of the first object.

The first object can be a boat and the second object can be a boat trailer, and wherein the software application can include a report generator configured to generate a status report indicating one or more of how many miles the boat has been hauled by the boat trailer, how fast the boat trailer has been moving while hauling the boat, how much weight the boat trailer has been carrying, how long the boat has been on the trailer, and how many G-forces have been applied to the boat trailer while hauling the boat, based on the received status data of the first object.

The second object can include one or more secondary sensors configured to provide operational data of the second object, and wherein the tracking device can be configured to communicate with the one or more secondary sensors of the second object to receive the operational data of the second object and to transmit received operational data of the second object to the software application in combination with the status data of the first object.

The secondary sensors can include one or more of a tire pressure sensor and indicator light sensor, and wherein the processor can be configured to process the received operational data to indicate whether tires of the second object are properly inflated and whether lights of the second object are functioning properly based on the operational data.

The processing unit can be configured to indicate the first object is being carried by the second object when the tracking device is connected to the secondary sensors.

Example embodiments of the present general inventive concept can also be achieved by a system of detecting status of an object, including a tracking device configured to be attachable to a first object, a GPS device configured to be attachable to a second object, the GPS device configured to communicate with the tracking device via a connection, and a software application configured to monitor the connection between the GPS device and the tracking device such that if the connection is broken, the software application sends an alert to a user that the second object may have been removed from the first object.

When the connection is broken, the GPS device can be configured to wake-up and send GPS location data of the second object to the software application.

Example embodiments of the present general inventive concept can also be achieved by a tracking device for use in a system to ascertain status of objects, including a GPS unit attachable to a first object to gather and transmit status data of a first object, a software application configured to receive transmitted status data of the first object from the GPS unit, and a processing unit configured to process received status data of the first object according to decision rules provided to the software application to determine if the first object is being carried by a second object, and if the processing unit determines the first object is being carried by the second object, the processing unit is configured to apply at least a portion of the received status data to the second object.

Certain implementations of the disclosed technology are described herein with reference to block diagrams of systems, and/or to configurations, functions, processes, or methods. It will be understood that one or more of the configurations, methods, processes, and functions can be implemented by computer-executable program instructions. Note that in some embodiments, one or more of the configurations, methods, processes, systems, and functions may not necessarily need to be performed in a particular order, or may not necessarily need to be performed at all.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

1. A system of ascertaining status of objects, comprising:
a tracking device attachable to a first object, the tracking device configured to collect and transmit status data of the first object;
a software application configured to receive transmitted status data of the first object from the tracking device; and
a processing unit configured to process received status data of the first object according to decision rules provided to the software application to determine if the first object is being carried by a second object, and if the processing unit determines the first object is being carried by the second object, the processing unit is configured to apply at least a portion of the received status data to the second object.

2. The system of claim 1, wherein the status data includes movement data and operational data, and the processing unit is configured to process the movement data to determine if the first object is moving at a speed above a predetermined level and to process the operational data to determine if an engine of the first object is on or off such that if the processing unit determines the first object is moving at a speed above a predetermined level with the engine off, the processing unit is configured to determine the first object is being carried by the second object.

3. The system of claim 1, wherein the status data includes location data, and the processing unit is configured to determine that the first object is being carried by the second object based on a comparison of the location data to map data provided to the software application.

4. The system of claim 3, wherein the status data includes movement data and the processing unit is configured to process the movement data to determine if the first object is moving at a speed above a predetermined level such that if the processing unit determines the first object is moving at a speed above a predetermined level at a predetermined location relative to the map data, the processing unit is configured to determine the first object is being carried by the second object.

5. The system of claim 4, wherein the processing unit is configured to determine whether the first object is moving on water or land based on the location data and map data.

6. The system of claim 1, wherein the status data includes battery voltage level data of the first object, and wherein the processing unit is configured to determine that the first object is moving but not operating based on received battery voltage level data.

7. The system of claim 1, wherein the first object includes one or more sensors configured to provide the status data of the first object.

8. The system of claim 7, wherein the one or more sensors include one or more of a temperature sensor, time sensor, vibration sensor, G-force sensor, XYZ sensor, accelerometer, weight sensor, and GPS sensor.

9. The system of claim 8, wherein the processor is configured to indicate the second object is carrying excess weight based on weight sensor data of the first object.

10. The system of claim 9, wherein the first object is a boat and the second object is a boat trailer, and wherein the software application includes a report generator configured to generate a status report indicating one or more of how many miles the boat has been hauled by the boat trailer, how fast the boat trailer has been moving while hauling the boat, how much weight the boat trailer has been carrying, how long the boat has been on the trailer, and how many G-forces have been applied to the boat trailer while hauling the boat, based on the received status data of the first object.

11. The system of claim 1, wherein the second object includes one or more secondary sensors configured to provide operational data of the second object, and wherein the tracking device is configured to communicate with the one or more secondary sensors of the second object to receive the operational data of the second object and to transmit received operational data of the second object to the software application in combination with the status data of the first object.

12. The system of claim 11, wherein the secondary sensors include one or more of a tire pressure sensor and indicator light sensor, and wherein the processor is configured to process the received operational data to indicate whether tires of the second object are properly inflated and whether lights of the second object are functioning properly based on the operational data.

13. The system of claim 11, wherein the processing unit is configured to indicate the first object is being carried by the second object when the tracking device is connected to the secondary sensors.

14. A system of detecting status of an object, comprising:
a tracking device configured to be attachable to a first object;
a GPS device configured to be attachable to a second object, the GPS device configured to communicate with the tracking device via a connection; and
a software application configured to monitor the connection between the GPS device and the tracking device such that if the connection is broken, the software application sends an alert to a user.

15. The system of claim 14, wherein when the connection is broken, the GPS device is configured to wake-up and send GPS location data of the second object to the software application.

16. A tracking device for use in a system to ascertain status of objects, the tracking device comprising:
a GPS unit attachable to a first object to gather and transmit status data of a first object;
a software application configured to receive transmitted status data of the first object from the GPS unit; and
a processing unit configured to process received status data of the first object according to decision rules provided to the software application to determine if the first object is being carried by a second object, and if the processing unit determines the first object is being carried by the second object, the processing unit is configured to apply at least a portion of the received status data to the second object.
